(19) United States
(12) Patent Application Publication
(10) Pub. No.: US 2014/0092412 A1
(43) Pub. Date: Apr. 3, 2014

(54) IMAGE FORMING APPARATUS AND IMAGE FORMING METHOD

(71) Applicant: SAMSUNG ELECTRONICS CO., LTD., Suwon-si (KR)

(72) Inventor: Jeong-yul JEONG, Incheon (KR)

(73) Assignee: Samsung Electronics Co., Ltd., Suwon-si (KR)

(21) Appl. No.: 13/856,480

(22) Filed: Apr. 4, 2013

(30) Foreign Application Priority Data
Oct. 2, 2012 (KR) 10-2012-0109729

(51) Int. Cl. H04N 1/23

(52) U.S. Cl. CPC H04N 1/2376
USPC 358/1.13

(57) ABSTRACT

An image forming apparatus and an image forming method are provided. The image forming apparatus includes: a communication interface which receives printing data; an image former which performs a printing process by using the received printing data; a counter which counts the number of jobs performed in a printing process; a non-volatile memory which stores the number of counted jobs; and a controller which, if a printing process is not performed for a preset time, resets the stored number of jobs to zero, and, if the stored number of jobs is higher than or equal to a preset value, changes an operation mode of the image forming apparatus to a cooling mode.

### CROSS-REFERENCE TO RELATED APPLICATIONS

This application claims priority under 35 U.S.C. §119 from Korean Patent Application No. 10-2012-109729, filed on Oct. 2, 2012, in the Korean Intellectual Property Office, the disclosure of which is incorporated herein by reference in its entirety.

### BACKGROUND OF THE INVENTION

1. Field of the Invention

The present general inventive concept generally relates to an image forming apparatus and an image forming method, and more particularly, to an image forming apparatus and an image forming method to prevent a cooling mode from being deactivated due to power being turned off, without using an additional temperature sensor.

2. Description of the Related Art

In general, an image forming apparatus refers to an apparatus which prints printing data generated in a terminal apparatus, such as a computer, on a recording paper sheet. Examples of an image forming apparatus include a copier, a printer, a fax machine, a multifunction peripheral (MFP), otherwise known as an all-in-one, which combines multiple functions in one device, and so on.

Among image forming apparatuses, a laser image forming apparatus has a faster printing speed and a higher image-quality than an ink-jet printing type image forming apparatus. Therefore, a laser image forming apparatus is being used more and more frequently.

However, a laser image forming apparatus generates a relatively large amount of heat due to an element such as a fuser or the like. Therefore, a fan and a cooling control are set in the laser image forming apparatus in order to reduce heat. Specifically, if the heat in the laser image forming apparatus is higher than a given threshold, components of the device are damaged by the heat. In particular, the heat affects the performance of printed circuit boards (PCBs) in the laser image forming apparatus, and thus reduces the performance of the whole system. Therefore, if a temperature in the laser image forming apparatus is higher than or equal to a predetermined temperature, the laser image forming apparatus performs a cooling process in order to lower the temperature.

If the laser image forming apparatus includes a temperature sensor, the laser image forming apparatus easily performs a cooling process as described above based on a measured temperature. However, a recent laser image forming apparatus performs a cooling process by tracking the time spent continuously printing or by tracking the number of continuously accumulated outputs, without a temperature sensor, in order to reduce manufacturing cost.

As described above, if a temperature sensor is not used, manufacturing cost is reduced. However, if power is switched off while the image forming apparatus is in a cooling mode, the cooling mode is frequently deactivated. Specifically, if power is shut off, a control parameter, such as a continuous printing time or the number of continuously accumulated outputs, is reset. Therefore, a high internal temperature is not recognized, and the device may be damaged by the excessive heat if it is turned back on and used before it can cool off.

### SUMMARY OF THE INVENTION

Exemplary embodiments of the present invention address at least the above problems and disadvantages, as well as other disadvantages not described above. Also, the exemplary embodiments are not required to overcome the disadvantages described above, and an exemplary embodiment may not overcome any of the problems described above.

Additional features and utilities of the present general inventive concept will be set forth in part in the description which follows and, in part, will be obvious from the description, or may be learned by practice of the general inventive concept.

The exemplary embodiments provide an image forming apparatus and an image forming method for preventing a cooling mode from being deactivated due to power being switched off, without using an additional temperature sensor.

Throughout this application, the word “job” is used in the context of continuously accumulated outputs generated by an image forming apparatus as part of an image forming operation. For example, a “job” could be printing an image onto a sheet of paper. Printing multiple sheets accordingly would mean performing multiple jobs.

According to an aspect of the exemplary embodiments, there is provided an image forming apparatus having a normal printing mode and a cooling mode. The image forming apparatus may include: a communication interface which receives printing data; an image former which performs a printing process by using the received printing data; a counter which counts the number of jobs performed in a printing process; a non-volatile memory which stores the number of counted jobs; and a controller which, if the printing process is not performed for a preset time, resets the number of jobs stored in the non-volatile memory to zero, and, if the number of jobs stored in the non-volatile memory is higher than or equal to a preset value, changes an operation mode of the image forming apparatus to a cooling mode.

If the number of jobs stored in the non-volatile memory is reset to zero when the operation mode of the image forming apparatus is the cooling mode, the controller may change the operation mode of the image forming apparatus to the normal printing mode.

If the image forming apparatus is powered on, the controller may determine the operation mode of the image forming apparatus based on the number of jobs stored in the non-volatile memory.

The counter may measure a time elapsed from when the printing process is completed or stopped. If the image forming apparatus is powered on, the number of jobs stored in the non-volatile memory is higher than or equal to the preset value, and the measured elapsed time does not exceed a preset time, the controller may determine the operation mode of the image forming apparatus as the cooling mode.

If the measured elapsed time exceeds the preset time, the controller may determine the operation mode of the image forming apparatus as the normal printing mode and reset the number of jobs stored in the non-volatile memory to zero.

The communication interface may acquire time information from an external host apparatus. The non-volatile memory may store the number of counted jobs and time information about when the jobs are counted. If the image forming apparatus is powered on, the controller may control the communication interface to acquire time information from the external host apparatus and determine whether a difference between the acquired time information and the time information stored in the nonvolatile memory is higher than or equal to a preset difference to determine the operation mode of the image forming apparatus.

The image forming apparatus may further include a sensor which senses feeding of a paper sheet to the image former. The controller may count the number of sheets sensed by the sensor as the number of counted jobs in the non-volatile memory.

The cooling mode of the image forming apparatus may be such that when the operation mode of the image forming apparatus is the cooling mode, no printing process is performed.

The cooling mode of the image forming apparatus may be such that when the operation mode of the image forming apparatus is the cooling mode, a printing process is performed at a slower printing speed than a printing speed of the normal printing mode.

The non-volatile memory may include: a volatile memory which stores the information; and a battery which supplies power to the volatile memory if the image forming apparatus is powered off.

According to another aspect of the exemplary embodiments, there is provided a method of using an image forming apparatus having a normal printing mode and a cooling mode. The method may include: receiving printing data; performing a printing process by using the received printing data; counting the number of jobs performed in the printing process and storing the number of jobs in a non-volatile memory; and if the number of jobs stored in the non-volatile memory is higher than or equal to a preset value, changing an operation mode of the image forming apparatus to the cooling mode.

The method may further include: if the printing process is not performed for a preset time, resetting the number of jobs stored in the non-volatile memory to zero.

The method may further include: if the number of jobs stored in the non-volatile memory is reset to zero when the operation mode of the image forming apparatus is the cooling mode, changing the operation mode of the image forming apparatus to the normal printing mode.

The method may further include: if the image forming apparatus is powered on, determining the operation mode of the image forming apparatus based on the number of jobs stored in the non-volatile memory.

The method may further include: measuring an elapsed time from when the printing process is completed or stopped. If the number of jobs stored in the non-volatile memory is the higher than or equal to the preset value and the measured elapsed time does not exceed a preset time, the operation mode of the image forming apparatus may be determined as the cooling mode.

If the image forming apparatus is powered on and the measured elapsed time exceeds the preset time, the number of jobs stored in the non-volatile memory may be reset to zero, and the operation mode of the image forming apparatus may be determined as the normal printing mode.

The method may further include: acquiring time information from an external host apparatus. The number of counted jobs and time information about when the jobs are counted may be stored. A communication interface may be controlled to acquire the time information from the external host apparatus, and a determination may be made as to whether a difference between the acquired time information and the time information stored in the non-volatile memory is higher than or equal to a preset difference to determine the operation mode of the image forming apparatus.

Whenever feeding of a paper sheet to an image former is sensed, the number of counted jobs stored in the non-volatile memory may be increased by the number of paper sheets that are sensed.

The cooling mode of the image forming apparatus may be such that when the operation mode of the image forming apparatus is the cooling mode, no printing process is performed.

The cooling mode of the image forming apparatus may be such that when the operation mode of the image forming apparatus is the cooling mode, a printing process is performed at a slower printing speed than a printing speed of the normal printing mode.

According to another aspect of the exemplary embodiments, there is provided an image forming apparatus. The image forming apparatus may include: a counter which counts the number of jobs performed in a printing process of the image forming apparatus, a non-volatile memory which stores the number of counted jobs, and a controller configured to switch an operation mode of the image forming apparatus from a normal printing mode to a cooling mode when the stored number of jobs is greater than or equal to a preset value, and to reset the stored number of jobs to zero and switch the operation mode to a normal printing mode if no job is performed for a preset time.

According to another aspect of the exemplary embodiments, there is provided an image forming method. The image forming method may include: receiving printing data, performing a printing process at an image forming apparatus by using the received printing data, counting the number of jobs performed in the printing process and storing the number of jobs in a non-volatile memory, changing an operation mode of the image forming apparatus from a normal printing mode to a cooling mode if the stored number of jobs is greater than or equal to a preset value, and resetting the stored number of jobs to zero and switching the operation mode to the normal printing mode if no job is performed for a preset time.

According to another aspect of the exemplary embodiments, there is provided an image forming apparatus. The image forming apparatus may include: a non-volatile memory which stores the value of a control parameter, said control parameter being increased when the image forming apparatus performs a printing process, and a controller configured to switch an operation mode of the image forming apparatus from a normal printing mode to a cooling mode when the value of the control parameter is greater than or equal to a preset value, and to reset the value of the control parameter stored in the non-volatile memory to zero and switch the operation mode to a normal printing mode if no printing process is performed for a preset time.

The control parameter may be the number of jobs performed in the printing process.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a structure of an image forming apparatus according to an exemplary embodiment of the present general inventive concept;

FIG. 2 is a block diagram illustrating a detailed structure of a controller of FIG. 1, according to an exemplary embodiment of the present general inventive concept;

FIG. 3 is a view illustrating a user interface (UI) window displayable on a UI of FIG. 1, according to an exemplary embodiment of the present general inventive concept;

FIG. 4 is a flowchart illustrating an image forming method according to an exemplary embodiment of the present general inventive concept;

FIG. 5 is a flowchart illustrating an operation of changing an operation mode of an image forming apparatus including a timer, according to an exemplary embodiment of the present general inventive concept; and

FIG. 6 is a flowchart illustrating an operation of changing of an operation mode of an image forming apparatus not including a timer, according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Thus, it is apparent that the exemplary embodiments can be carried out without those specifically defined matters. Also, well-known functions or constructions are not described in detail since they would obscure the exemplary embodiments with unnecessary detail.

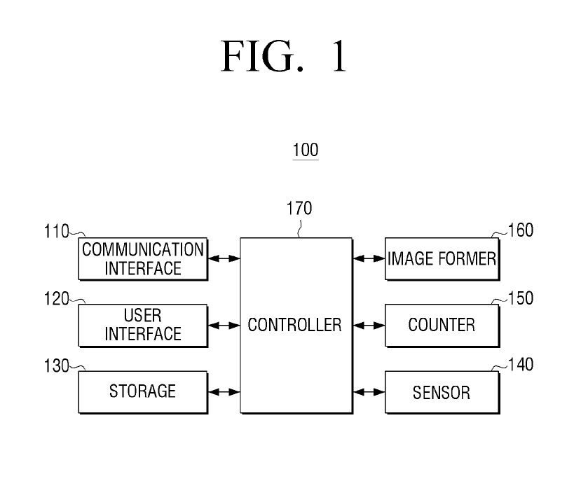

FIG. 1 is a block diagram illustrating a structure of an image forming apparatus 100 according to an exemplary embodiment of the present general inventive concept.

Referring to FIG. 1, the image forming apparatus 100 includes a communication interface 110, a user interface (UI) 120, a storage 130, a sensor 140, a counter 150, an image former 160, and a controller 170. Here, the image forming apparatus 100 may be, for example, a copier, a printer, a fax machine, or a multifunction peripheral (MFP) which performs a printing process by using a laser printing method.

The communication interface 110 is formed to connect the image forming apparatus 100 to an external apparatus. The communication interface 110 may connect the image forming apparatus 100 to the external apparatus through a local area network (LAN) and the Internet, through a universal serial bus (USB) port, or a wireless module. Here, the external apparatus may be a print controlling apparatus such as a personal computer (PC) or the like, not illustrated in the Figures.

The communication interface 110 receives a request for performing a process. Specifically, the communication interface 110 may receive a request for performing a process related to a function of the image forming apparatus 100, such as a printing process, a scanning process, or a faxing process, from the print controlling apparatus. The communication interface 110 transmits and receives data (e.g., printing data, scan data, etc.) related to each process. Here, the printing data may be data of a printer language such as a postscript (PS), a printer control language (PCL), or the like. If the image forming apparatus 100 supports direct printing, the printing data may be a file such as PDF, XPS, BMP, JPG, or the like.

The communication interface 110 transmits a process performance result to the external apparatus. For example, if the external apparatus requests the process performance result for a scanning process, the communication interface 110 transmits a scan result obtained from the scanning process to the external apparatus. If the external apparatus requests the process performance result for a printing process, the communication interface 110 informs the external apparatus that the printing process is completed.

The communication interface 110 receives time information for the print controlling apparatus. If the operation mode of the image forming apparatus 100 is changed to a cooling mode (also called a stress mode), the communication interface 110 informs the print controlling apparatus that the cooling mode is changed. The time information for this change is received as well.

The UI 120 includes a plurality of functional keys through which a user sets or selects various functions supported by the image forming apparatus 100. The UI 120 also displays various types of information provided from the other components of the image forming apparatus 100, detailed below. The UI 120 may be realized as a device which simultaneously realizes an input and an output, such as a touch screen or the like.

The UI 120 displays the operation mode of the image forming apparatus 100. For example, if the operation mode of the image forming apparatus 100 is changed to the cooling mode, the UI 120 displays that the operation mode of the image forming apparatus 100 is changed to the cooling mode.

The storage 130 stores the received printing data. Specifically, the storage 130 stores the printing data received through the communication interface 110.

The storage 130 also stores a control parameter. Here, the control parameter may be the number of jobs (or the number of continuously accumulated outputs) counted by the counter 150 which will be described later. The storage 130 may be realized as a non-volatile memory. For example, the storage 130 may be realizes a flash read only memory (ROM), an electrically erasable programmable ROM (EPPROM), or a combination of a non-volatile memory and a battery.

The storage 130 stores the control parameter and time information about when the control parameter is stored. Specifically, if the time information is obtained through the communication interface 110, the storage 130 stores the control parameter and time information about when the control parameter is updated (such as when a printing paper sheet is supplied).

In the present exemplary embodiment, one structure stores printing data and the number of jobs. However, the storage 130 may be realized as a non-volatile memory or a volatile memory. In this case, the printing data may be stored in the volatile memory and a job parameter may be stored in the non-volatile memory.

The sensor 140 senses feeding of paper sheets to the image former 160. Specifically, the sensor 140 senses feeding of paper sheets to the image former 160 by using a sensor which detects the presence of a printed paper sheet, or a sensor which detects the feeding of a paper sheet from the image former 160.

The counter 150 counts the number of jobs performed in a printing process. Specifically, the counter 150 counts the number of jobs corresponding to pages of a printing process performed by the image former 160. A counting value may be reset to zero if the printing process is not performed for a preset time or the cooling mode is maintained for the preset time. In the present exemplary embodiment, the number of jobs is used as the control parameter. However, another parameter (e.g., an operation time of a fuser) may be used.

The image former 160 forms an image. Specifically, the image former 160 forms the image of the printing data received through the communication interface 110. Only the image former 160 performing the printing process is illustrated in the present exemplary embodiment. However, if the image forming apparatus 100 is an MFP which performs a scanning process and a faxing process, the image forming apparatus 100 may further include an element performing the scanning process and an element performing a fax transmitting/receiving process.

The controller 170 controls elements of the image forming apparatus 100. Specifically, if the printing data is received through the communication interface 110, the controller 170 controls the image former 160 to print the received printing data. The controller 170 controls the counter 150 to count and store the number of jobs performed in the printing process. This storing operation may be performed whenever the feeding of the paper sheet to the image former 160 occurs.

The controller 170 determines a change of the operation mode of the image forming apparatus 100. In more detail, if the controller 170 satisfies a preset condition, the controller 170 determines a need to change the operation mode of the image forming apparatus 100 from a normal printing mode to the cooling mode. Here, as described above, the preset condition may be that the number of continuously performed jobs is higher than or equal to a preset value, an operation time of the fuser is longer than or equal to a preset time, or an internal temperature of the image forming apparatus 100 is higher than or equal to a preset temperature (if the image forming apparatus 100 includes a temperature sensor). Any other control parameter stored in a conventional volatile memory may also be used. In the present exemplary embodiment, based off of the control parameter a determination is made as to whether an operation mode is to be changed.

If the preset condition is satisfied, the controller 170 changes the normal printing mode to the cooling mode. In the present exemplary embodiment, if the number of jobs stored in the non-volatile memory is higher than or equal to the preset value, the controller 170 changes the operation mode of the image forming apparatus 100 to the cooling mode. For example, if the number of pages per minute (ppm) of the image forming apparatus 100 is 30 ppm, and the image forming apparatus 100 continuously performs printing on 150 paper sheets, the controller 170 may determine that there is excessive internal heat in the image forming apparatus 100. In this case, the controller 170 changes the operation mode of the image forming apparatus 100 from the normal printing mode to the cooling mode.

Here, the normal printing mode refers to a mode in which the image forming apparatus 100 performs a normal operation. In the above example, it is the mode in which the image forming apparatus 100 prints at 30 ppm. The cooling mode refers to a mode in which, for example, the printing speed is lowered to less than that of the normal printing mode, or printing is temporarily halted and an internal fan (not shown) of the image forming apparatus 100 is operated in order to emit internal heat of the image forming apparatus.

If the printing process is not performed for the preset time, the controller 170 resets the control parameter (e.g., the number of jobs) stored in the non-volatile memory to zero. For example, if 5 minutes passes after a final printing process is performed, the controller 170 determines that the internal heat resulting from a previous printing process of the image forming apparatus 100 is at a level that does not affect performance, and thus resets the control parameter (e.g., the number of jobs) stored in the non-volatile memory to zero.

If the operation mode of the image forming apparatus 100 is the cooling mode, and the control parameter is reset to zero, the controller 170 changes the operation mode of the image forming apparatus 100 from the cooling mode to the normal printing mode.

If the image forming apparatus 100 is turned on, the controller 170 determines the operation mode of the image forming apparatus based on the control parameter (e.g., the number of jobs) stored in the non-volatile memory. Specifically, if the control parameter stored in the non-volatile memory is not a value requiring a change to the cooling mode, the controller 170 determines the operation mode of the image forming apparatus 100 as the normal printing mode.

If the control parameter stored in the non-volatile memory is the value requiring the change to the cooling mode, the controller 170 determines the operation mode of the image forming apparatus 100 as the cooling mode. In the present exemplary embodiment as described above, the control parameter used for determining the change of the operation mode of the image forming apparatus 100 is stored in the non-volatile memory. Therefore, even if the image forming apparatus 100 is temporarily turned off, the image forming apparatus 100 may operate in an operation mode appropriate for an internal temperature of the image forming apparatus 100 when the image forming apparatus 100 is turned back on.

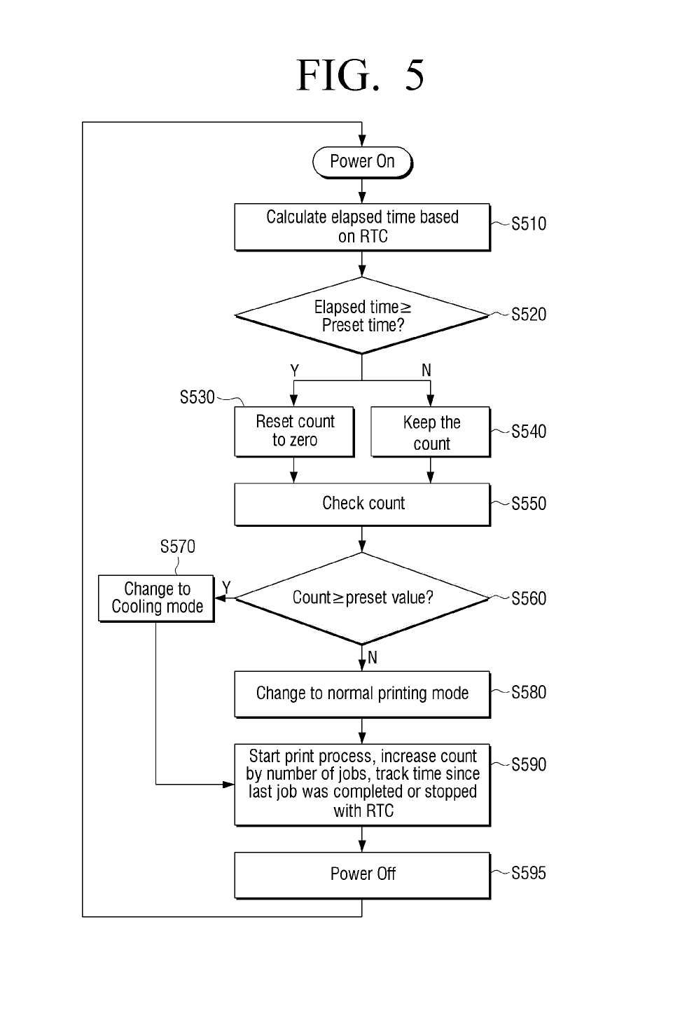

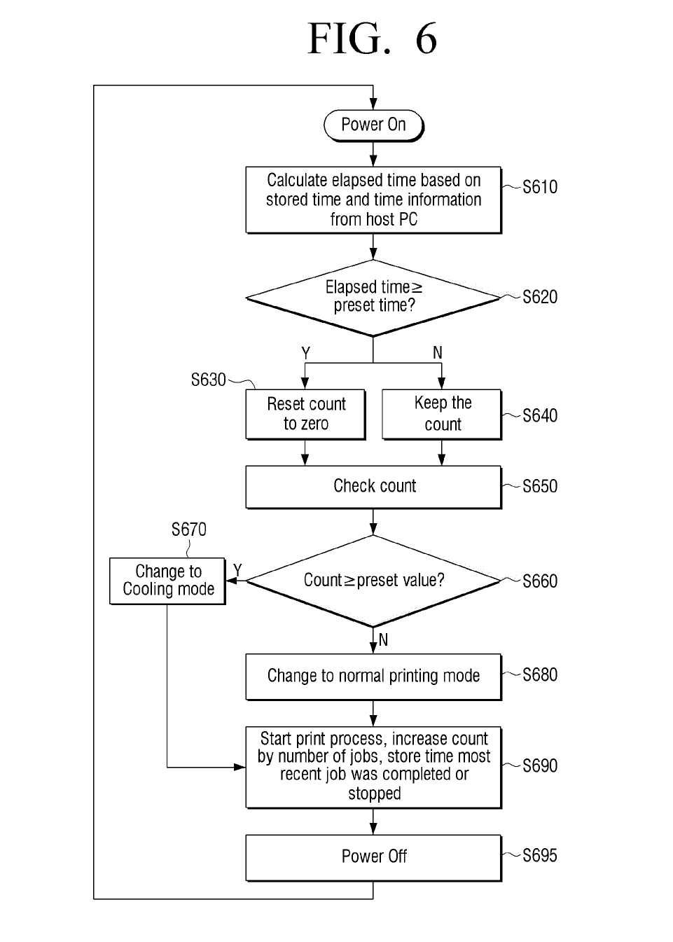

If the image forming apparatus 100 is powered down for a sufficiently long time, i.e., the internal temperature of the image forming apparatus 100 is lowered and thus does not require cooling, the image forming apparatus 100 does not need to operate in the cooling mode although the image forming apparatus 100 is powered up. Therefore, even if the control parameter stored in the non-volatile memory is the value requiring the change to the cooling mode, and the image forming apparatus 100 is powered down for a preset time or more, the controller 170 determines the operation mode of the image forming apparatus 100 as the normal printing mode. Here, a time for powering down the image forming apparatus 100 may be set by a timer of the image forming apparatus 100 (not shown) or may be set by using time information of an external host apparatus as the external apparatus. An operation of the image forming apparatus 100 including the timer will be described later with reference to FIG. 5. An operation of the image forming apparatus 100 not including the timer will be described later with reference to FIG. 6.

As described above, the image forming apparatus 100 according to the present exemplary embodiment stores the control parameter used for determining whether the image forming apparatus is to be changed to the cooling mode, in the non-volatile memory. Therefore, even if the image forming apparatus 100 is suddenly powered down, the image forming apparatus 100 prevents the cooling mode from being released. Also, the image forming apparatus 100 may perform the above-described operation without a temperature sensor, and thus manufacturing cost of the image forming apparatus 100 may be reduced.

In FIG. 1, the counter 150 and the controller 170 are separate elements. However, a function of the counter 150 and a function of the controller 170 may be realized as one element.

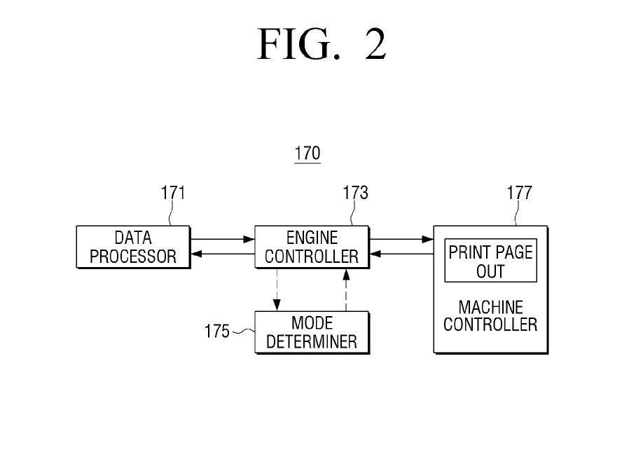

As described with reference to FIG. 1, the image former 160 performs the printing process by using the received printing data. However, the controller 170 may perform rendering and image processing with respect to the received printing data, and the image former 160 may receive the image-processed data to perform the printing process. A structure and an operation of the controller 170 in this case will now be described with reference to FIG. 2.

FIG. 2 is a block diagram illustrating a detailed structure of the controller 170 of FIG. 1.

Referring to FIG. 2, the controller 170 includes a data processor 171, an engine controller 173, a mode determiner 175, and a machine controller 177.

The data processor 171 converts the received printing data into data processible by the image former 160. Specifically, the data processor 171 performs a process, such as rendering, halftoning, or the like, with respect to the received printing data to generate binary image data and provides the generated binary image data to the image former 160.

The engine controller 173 controls an operation state of the image former 160. Specifically, if the operation mode of the image forming apparatus 100 is the normal printing mode, the engine controller 173 controls the image former 160 to perform the printing process at a preset printing speed. If instead the operation mode of the image forming apparatus 100 is the cooling mode, the engine controller 173 controls the image former 160 to perform the printing process according to the cooling mode, such as operating at a relatively slower printing speed or temporarily halting the printing process.

If the sensor 140 senses feeding of a paper sheet, the mode determiner 175 counts the number of sheets being fed and stores the counted number of sheets as a number of jobs in the non-volatile memory. The control parameter (e.g. the number of jobs) is stored in the non-volatile memory. Therefore, even when power is turned off, a value counted before the power is turned off is maintained. As a result, if the power is turned back on, it can still be determined that the cooling mode is necessary, based on the control parameter stored in the non-volatile memory. The control parameter may be stored in the non-volatile memory whenever the sensor 140 senses an event or at times pre-designated by the controller 170.

If the number of jobs stored in the non-volatile memory is greater than or equal to a preset value for the cooling mode, the mode determiner 175 determines that a change to the cooling mode is required.

If the image former 160 does not perform the printing process for a preset time or the cooling mode is maintained for the preset time, the mode determiner 175 resets the number of jobs stored in the non-volatile memory. If the number of jobs stored in the non-volatile memory is reset in the cooling mode, the mode determiner 175 changes the operation mode of the image forming apparatus from the cooling mode to the normal printing mode.

If the image forming apparatus 100 is turned off, the mode determiner 175 determines the operation mode of the image forming apparatus 100 based on the number of jobs stored in the non-volatile memory. For example, if the number of jobs stored in the non-volatile memory is greater than or equal to the preset value for the cooling mode, the mode determiner 175 determines the operation mode of the image forming apparatus 100 as the cooling mode.

If the number of jobs stored in the non-volatile memory less than the preset value for the cooling mode, the mode determiner 175 determines the operation mode of the image forming apparatus 100 as the normal printing mode and resets the number of jobs stored in the non-volatile memory to zero.

Even if the number of jobs stored in the non-volatile memory is equal to the preset value for the cooling mode, if the image forming apparatus 100 is turned off for the preset time or more, the mode determiner 175 determines the operation mode of the image forming apparatus 100 as the normal printing mode and resets the number of jobs stored in the non-volatile memory to zero.

The machine controller 177 controls the elements of the image forming apparatus 100. Specifically, if the sensor 140 senses the feeding of the paper sheet, the machine controller 177 provides the sensor output to the mode determiner 175.

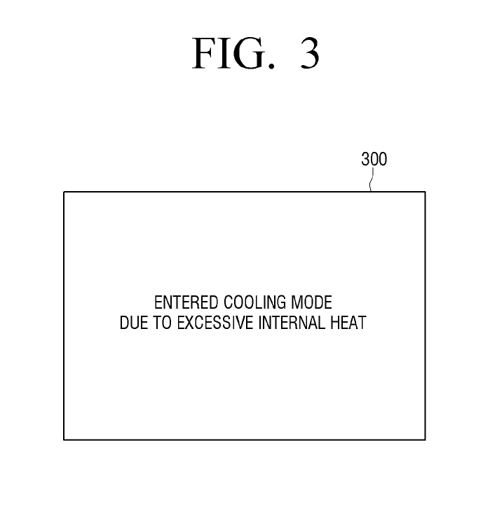

FIG. 3 is a view illustrating a UI window 300 displayable on the UI 120 of FIG. 1, according to an exemplary embodiment of the present general inventive concept.

Referring to FIG. 3, the UI window 300 informs a user that an operation mode is changed. The UI window 300 may be limited to providing only information about that an operation mode of an image forming apparatus is a cooling mode. However, the UI window 300 may also provide time information about how long the cooling mode is maintained, along with the information that the operation mode of the image forming apparatus is the cooling mode.

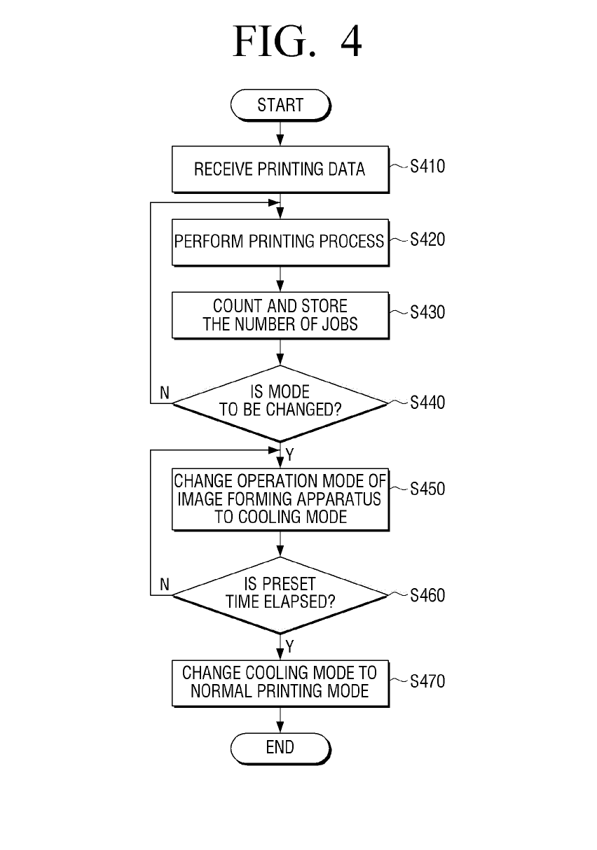

FIG. 4 is a flowchart illustrating an image forming method according to an exemplary embodiment of the present general inventive concept.

Referring to FIG. 4, in operation S410, printing data is received. For example, the printing data may be received from an external apparatus.

In operation S420, a printing process is performed by using the received printing data. For example, if an operation mode of the image forming apparatus 100 is a normal printing mode, the printing process is performed with respect to the received printing data.

In operation S430, the number of jobs performed in the printing process is counted and stored in a non-volatile memory. For example, whenever it is sensed that a sheet of paper is fed to an image former, the number of sheets may be stored in the non-volatile memory as the number of counted jobs.

In operation S440, a determination is made as to whether the operation mode of the image forming apparatus 100 is to be changed, based on the number of counted jobs stored in the non-volatile memory. If number of jobs stored in the non-volatile memory is higher than or equal to a preset value, it is determined in operation S440 that the operation mode of the image forming apparatus 100 is to be changed to a cooling mode. Therefore in operation S450, the operation mode of the image forming apparatus 100 is changed to the cooling mode. Here, the cooling mode refers to a mode in which a printing speed is lowered to a speed less than that of the normal printing mode, or printing is temporarily halted and a fan (not shown) of the image forming apparatus 100 is operated in order to emit internal heat of the image forming apparatus 100.

If the number of counted jobs stored in the non-volatile memory is lower than or equal to the preset value, it is determined in operation S440 that the operation mode of the image forming apparatus 100 is not to be changed, and the printing process continues. The determination operation may be performed even if the image forming apparatus 100 is turned off and then turned back on. Specifically, if the image forming apparatus is turned off and subsequently turned on, a determination may still be made as to whether a control parameter stored in the non-volatile memory is a value requiring a change to the cooling mode.

If the operation mode of the image forming apparatus 100 is changed to the cooling mode in operation S450, a determination is made as to whether the cooling mode has been maintained for a preset time in operation S460. If it is determined in operation S460 that the cooling mode has been maintained for the preset time or more, the operation mode of the image forming apparatus 100 is changed from the cooling mode to the normal printing mode in operation S470, and the number of counted jobs stored in the non-volatile memory is reset to zero.

If the operation mode of the image forming apparatus 100 is changed to the normal printing mode, and there is printing data to be printed as described above, the image forming apparatus 100 performs a printing process of the remaining printing data in the normal printing mode.

As described above, the image forming method according to the present exemplary embodiment stores the control parameter used for determining whether the change to the cooling mode is required in the non-volatile memory. Therefore, even if the image forming apparatus 100 is suddenly turned off, the cooling mode is prevented from being released. This operation may be performed without using an additional temperature sensor, and thus manufacturing cost of the image forming apparatus 100 may be reduced. The image forming method of FIG. 4 may be performed in an image forming apparatus having the structure of FIG. 1 or image forming apparatuses having other types of structures.

The above-described image forming method may be embodied as a program including a computer executable algorithm, and the program may be stored and provided on a non-transitory computer readable medium.

The non-transitory computer readable medium refers to a medium which does not store data for a short time such as a register, a cache memory, a memory, or the like but semi-permanently stores data and is readable by a device. For example, the above-described applications or programs may be stored and provided on a non-transitory computer readable medium such as a CD, a DVD, a hard disk, a Blu-ray disk, a universal serial bus (USB), a memory card, a ROM, or the like.

FIG. 5 is a flowchart illustrating an operation of changing an operation mode of the image forming apparatus 100 including a timer, according to an exemplary embodiment of the present general inventive concept.

Referring to FIG. 5, if the image forming apparatus 100 is powered on, in operation S510, an elapsed time is measured from when the image forming apparatus 100 is powered on to when the image forming apparatus 100 is powered off by using a real time clock (RTC). Alternatively, an elapsed time may be measured from when the last printing of the image forming apparatus 100 is completed or when printing of the image forming apparatus 100 stops, by using the RTC.

In operation S520, a determination is made as to whether the measured elapsed time exceeds a preset time. For example, a determination may be made as to whether the elapsed time exceeds 5 minutes. The preset time may be different in each image forming apparatus. Specifically, different models of image forming apparatuses may lose heat at different rates. Therefore, a manufacturer may pre-set an elapsed time appropriate for the specific image forming apparatus.

If it is determined in operation S520 that the measured elapsed time exceeds the preset time, a control parameter stored in a non-volatile memory, which for example may be the count of jobs as indicated in FIG. 5, is reset to zero in operation S530.

If it is determined in operation S520 that the measured elapsed time does not exceed the preset time, the control parameter stored in the non-volatile memory is maintained in operation S540.

In operations S550 and S560, an operation mode of the image forming apparatus 100 is determined by using the control parameter stored in the non-volatile memory. Specifically, in operation S550, the control parameter is checked. In operation S560, a determination is made as to whether the control parameter stored in the non-volatile memory indicates that the image forming apparatus 100 needs to operate in a cooling mode. If it does, the operation mode of the image forming apparatus 100 is determined as the cooling mode.

If it is not determined that the stored control parameter indicates that the image forming apparatus 100 needs to operate in the cooling mode, the operation mode of the image forming apparatus 100 is determined as a normal printing mode.

If the operation mode of the image forming apparatus 100 is determined as the cooling mode in operation S560, the operation mode of the image forming apparatus 100 is changed to the cooling mode to allow the image forming apparatus 100 to operate in the cooling mode in operation S570. For example, a printing process may be performed at a slower printing speed relative to the normal printing mode, or printing is temporarily halted and the fan of the image forming apparatus 100 is operated in order to emit internal heat of the image forming apparatus 100.

If the operation mode of the image forming apparatus 100 is determined as the normal printing mode in operation S560, the operation mode of the image forming apparatus 100 is changed to the normal printing mode in operation S580. If a printing process is performed, the number of jobs performed in the printing process is counted and then stored in the non-volatile memory in operation S590, and the time since the last job was completed or stopped is tracked with the RTC.

Even if the image forming apparatus 100 is powered off in operation S595, the number of counted jobs is stored in the non-volatile memory. Therefore, even if the image forming apparatus 100 is powered off, the image forming apparatus 100 is prevented from changing its operation mode from the cooling mode to the normal printing mode.

FIG. 6 is a flowchart illustrating an operation of changing an operation mode of the image forming apparatus 100 not including a timer, according to an exemplary embodiment of the present general inventive concept.

Referring to FIG. 6, if the image forming apparatus 100 is powered on, the image forming apparatus 100 receives time information from a host apparatus. In operation S610, an elapsed time is calculated from when the image forming apparatus 100 is powered off to when the image forming apparatus 100 is powered on, by using the time information stored in the non-volatile memory on when the most recent job was completed or stopped.

In operation S620, a determination is made as to whether the elapsed time exceeds a preset time. For example, a determination may be made as to whether the elapsed time exceeds 5 minutes.

If it is determined in operation S620 that the elapsed time exceeds the preset time, a control parameter stored in a non-volatile memory, which for example may be the count of jobs as indicated in FIG. 6, is reset to zero in operation S630.

If it is determined in operation S620 that the elapsed time does not exceed the preset time, the control parameter stored in the non-volatile memory is maintained in operation 640.

In operation S650 and S660, an operation mode of the image forming apparatus 100 is determined by using the control parameter stored in the non-volatile memory. Specifically, in operation S650, the control parameter is checked. In operation S660, a determination is made as to whether the control parameter stored in the non-volatile memory indicates that the image forming apparatus 100 needs to operate in the cooling mode. If it does, the operation mode of the image forming apparatus 100 is determined as the cooling mode.

If it is not determined that the control parameter indicates that the image forming apparatus 100 needs to operate in the cooling mode, the operation mode of the image forming apparatus 100 is determined as the normal printing mode.

If the operation mode of the image forming apparatus 100 is determined as the cooling mode in operation S660, the operation mode of the image forming apparatus 100 is changed to the cooling mode to allow the image forming apparatus 100 to operate in the cooling mode in operation S670. For example, a printing process may be performed at a slower printing speed relative to the normal printing mode, or printing is temporarily halted and the fan of the image forming apparatus 100 is operated, thereby emitting internal heat of the image forming apparatus 100.

If the operation mode of the image forming apparatus 100 is determined as the normal printing mode in operation S660, the operation mode of the image forming apparatus 100 is changed to the normal printing mode in operation S680. If the printing process is performed, the number of jobs performed in the printing process is counted and stored in the non-volatile memory in operation S690, along with time information on when the most recent job was completed or stopped.

Even if the image forming apparatus 100 is powered off in operation S695, the number of counted jobs and the time information on the most recent job and is stored in the non-volatile memory. Therefore, even if the image forming apparatus 100 is powered off, the image forming apparatus 100 is prevented from changing its operation mode from the cooling mode to the normal printing mode.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus having a normal printing mode and a cooling mode, the image forming apparatus comprising:
a communication interface which receives printing data;
an image former which performs a printing process by using the received printing data;
a counter which counts the number of jobs performed in a printing process;
a non-volatile memory which stores the number of counted jobs; and
a controller which, if the printing process is not performed for a preset time, resets the number of jobs stored in the non-volatile memory to zero, and, if the number of jobs stored in the non-volatile memory is higher than or equal to a preset value, changes an operation mode of the image forming apparatus to a cooling mode.

2. The image forming apparatus of claim 1, wherein if the number of jobs stored in the non-volatile memory is reset to zero when the operation mode of the image forming apparatus is the cooling mode, the controller changes the operation mode of the image forming apparatus to the normal printing mode.

3. The image forming apparatus of claim 1, wherein if the image forming apparatus is powered on, the controller determines the operation mode of the image forming apparatus based on the number of jobs stored in the non-volatile memory.

4. The image forming apparatus of claim 3, wherein:
the counter measures a time elapsed from when the printing process is completed or stopped; and
if the image forming apparatus is powered on, the number of jobs stored in the non-volatile memory is higher than or equal to the preset value, and the measured elapsed time does not exceed a preset time, the controller determines the operation mode of the image forming apparatus as the cooling mode.

5. The image forming apparatus of claim 4, wherein if the measured elapsed time exceeds the preset time, the controller determines the operation mode of the image forming apparatus as the normal printing mode and resets the number of jobs stored in the non-volatile memory to zero.

6. The image forming apparatus of claim 1, wherein the communication interface acquires time information from an external host apparatus;
the non-volatile memory stores the number of counted jobs and time information about when the jobs are counted; and if the image forming apparatus is powered on, the controller controls the communication interface to acquire time information from the external host apparatus and the controller determines whether a difference between the acquired time information and the time information stored in the non-volatile memory is higher than or equal to a preset difference to determine the operation mode of the image forming apparatus.

7. The image forming apparatus of claim 1, further comprising:
a sensor which senses feeding of a paper sheet to the image former,
wherein the controller counts the number of sheets sensed by the sensor as the number of counted jobs in the non-volatile memory.

8. The image forming apparatus of claim 1, wherein when the operation mode of the image forming apparatus is the cooling mode, no printing process is performed.

9. The image forming apparatus of claim 1, wherein when the operation mode of the image forming apparatus is the cooling mode, a printing process is performed at a slower printing speed than a printing speed of the normal printing mode.

10. The image forming apparatus of claim 1, wherein the non-volatile memory comprises:
a volatile memory which stores the information; and
a battery which supplies power to the volatile memory if the image forming apparatus is powered off.

11. A method of using an image forming apparatus having a normal printing mode and a cooling mode, the method comprising:
receiving printing data;
performing a printing process by using the received printing data;
counting the number of jobs performed in the printing process and storing the number of jobs in a non-volatile memory; and
if the number of jobs stored in the non-volatile memory is higher than or equal to a preset value, changing an operation mode of the image forming apparatus to the cooling mode.

12. The method of claim 11, further comprising:
if the printing process is not performed for a preset time, resetting the number of jobs stored in the non-volatile memory to zero.

13. The method of claim 12, further comprising:
if the number of jobs stored in the non-volatile memory is reset to zero when the operation mode of the image forming apparatus is the cooling mode, changing the operation mode of the image forming apparatus to the normal printing mode.

14. The method of claim 11, further comprising:
if the image forming apparatus is powered on, determining the operation mode of the image forming apparatus based on the number of jobs stored in the non-volatile memory.

15. The method of claim 14, further comprising:
measuring an elapsed time from when the printing process is completed or stopped,
wherein if the number of jobs stored in the non-volatile memory is the higher than or equal to the preset value and the measured elapsed time does not exceed a preset time, the operation mode of the image forming apparatus is determined as the cooling mode.

16. The method of claim 15, wherein if the image forming apparatus is powered on and the measured elapsed time exceeds the preset time, the number of jobs stored in the non-volatile memory is reset to zero, and the operation mode of the image forming apparatus is determined as the normal printing mode.

17. The method of claim 14, further comprising:
acquiring time information from an external host apparatus,
wherein:
the number of counted jobs and time information about when the jobs are counted are stored; and
a communication interface is controlled to acquire the time information from the external host apparatus, and a determination is made as to whether a difference between the acquired time information and the time information stored in the non-volatile memory is higher than or equal to a preset difference to determine the operation mode of the image forming apparatus.

18. The method of claim 11, wherein whenever feeding of a paper sheet to an image former is sensed, the number of counted jobs stored in the non-volatile memory is increased by the number of paper sheets that are sensed.

19. The method of claim 11, wherein when the operation mode of the image forming apparatus is the cooling mode, no printing process is performed.

20. The method of claim 11, wherein when the operation mode of the image forming apparatus is the cooling mode, the printing process is performed at a slower printing speed than a printing speed of the normal printing mode.
